(19) United States
(12) Patent Application Publication
(10) Pub. No.: US 2018/0018638 A1
(43) Pub. Date: Jan. 18, 2018

(54) METHOD, SYSTEM, AND NON-TRANSITORY COMPUTER-READABLE RECORDING MEDIUM FOR SUPPORTING SCHEDULE MANAGEMENT

(71) Applicant: Konolabs, Inc., Seoul (KR)

(72) Inventor: Dae Hoo Kim, Seoul (KR)

(73) Assignee: Konolabs, Inc., Seoul (KR)

(21) Appl. No.: 15/718,800

(22) Filed: Sep. 28, 2017

Related U.S. Application Data
(63) Continuation of application No. PCT/KR2017/001125, filed on Feb. 2, 2017.

(30) Foreign Application Priority Data
Feb. 3, 2016 (KR) 10-2016-0013666

(51) Int. Cl. G06Q 10/10

(52) U.S. Cl. CPC G06Q 10/1095

(57) ABSTRACT

The present invention relates to a method, system, and non-transitory computer-readable recording medium for supporting schedule management. According to an aspect of the present invention, a, method for supporting schedule management includes determining, as candidate time periods, at least one time period that is considered to be suitable for event generation among time periods within a first user's schedule, by making reference to context information of the first user; providing, to the first user, a first user interface for supporting the first user in inputting information for at least one candidate time period among the determined candidate time periods; and determining, as a preferred time period, at least one candidate time period for which the first user has a preference equal to or higher than a predetermined level among the candidate time periods, by making reference to the preference information input through the first user interface.

### CROSS-REFERENCE TO RELATED APPLICATIONS

This application is a continuation application of Patent Cooperation Treaty (PCT) international application Serial No. PCT/KR2017/001125, filed on Feb. 2, 2017, which claims priority to Korean Patent Application Serial No. 10-2016-0013666, filed on Feb. 3, 2016. The entire contents of PCT international application Serial No. PCT/KR2017/001125, and Korean Patent Application Serial No. 10-2016-0013666 are hereby incorporated by reference.

### FIELD OF THE INVENTION

The present invention relates to a method, system, and non-transitory computer-readable recording medium for supporting schedule management.

### BACKGROUND

In order to create a new event in a conventional calendar program (or application), a user should personally find an empty time slot in a time table, and manually enter specific information on the event one by one, such as a to-do item, location, start time, end time, recurrence, and notification time before the event. Therefore, a problem occurs in that the user should take much time and effort to manage schedule. Although a variety of calendar programs are developed recently, those calendar programs simply differ in terms of exterior elements such as designs or titles, and basically have the same problem as above.

Further, a conventional calendar program may only provide schedule management functionality for a single user, and thus, when managing an event in which two or more users are involved, the users cannot avoid the inconvenience of personally contacting each other separately from the calendar program to discuss about the time or location of the event, and entering information on the determined time or location of the event into the calendar program, one by one.

Meanwhile, in order to address the above problem of conventional calendar programs, there have been introduced programs for supporting convenient management of to-do lists. Such a to-do list management program may function to allow a user to conveniently enter and list his/her to-do items and to check the completion of the to-do items, but cannot give consideration to the duration of each to-do item or other events included in the user's schedule. Thus, the program has a limitation in that it is difficult to generally manage the user's schedule using the program.

In this connection, the inventor (s) present a technique for simplifying a process determining a time period of an event that two or more users attend together.

### SUMMARY OF THE INVENTION

One object of the present invention is to solve all the above problems in prior art.

Another object of the invention is to simplify a process of determining a time period of an event that two or more users attend together, by determining, as candidate time periods, at least one time period judged to be suitable for event creation among time periods within a first user's schedule, with reference to context information of the first user; providing the first user with a first user interface for supporting the first in inputting preference information for at least one of the determined candidate time periods; and determining, as preferred time periods,at least one candidate time period for which the first user has a preference of a predetermined level or higher among the candidate time periods, with reference to the preference information inputted through the first user interface.

The representative configurations of the invention to achieve the above objects are described below.

According to one aspect of the invention, there is provided a method for supporting schedule management, comprising the steps of: determining, as candidate time periods, at least one time period judged to be suitable for event creation among time periods within a first user's schedule, with reference to context information of the first user; providing the first user with a first user interface for supporting the first user in inputting preference information for at least one of the determined candidate time periods; and determining, as preferred time periods, at least one candidate time period for which the first user has a preference of a predetermined level or higher among the candidate time periods, with reference to the preference information inputted through the first user interface.

According to another aspect of the invention, there is provided a system for supporting schedule management, comprising: a time period recommendation unit configured to determine, as candidate time periods, at least one time period judged to be suitable for event creation among time periods within a first user's schedule, with reference to context information of the first user; and an event creation support unit configured to provide the first user with a first user interface for supporting the first user in inputting preference information for at least one of the determined candidate time periods, and to determine, as preferred time periods, at least one candidate time period for which the first user has a preference of a predetermined level or higher among the candidate time periods, with reference to the preference information inputted through the first user interface.

In addition, there are further provided other methods and systems to implement the invention, as well as non-computer-readable recording media having stored thereon computer programs for executing the methods.

According to the invention, it is possible to selectively provide a user who desires to determine a time period for creation of an event (i.e., an appointment with M another person) with only several candidate time periods judged to be suitable for the event creation, rather than with all time periods included in the user's schedule, so that the user may easily and quickly determine the time period for the event creation.

According to the invention, a time period of an event may be determined by a user merely inputting simple operations for several candidate time periods or preferred time periods, so that a process of determining a time period of an event that two or more users attend together may be simplified.

According to the invention, even if a service provider does not have schedule information of all users who will attend an event, the event may be created in a time period that may satisfy all the users, on the basis of schedule information of any one of the users (e.g., a user who is subscribed to the service)

According to the invention, users who are using different types of schedule management services may also easily and quickly create an event in which the users meet each other.

### BRIEF DESCRIPTION OF THE DRAWINGS

FIG. 1 schematically shows the configuration of an entire system for supporting schedule management according to one embodiment of the invention.

FIG. 2 illustratively shows the internal configuration of a service provision system according to one embodiment of the invention.

FIGS. 3A to 3F illustratively show service screens that may be provided to a first user according to one embodiment of the invention.

FIGS. 4A to 4C illustratively show service screens that may be provided to a second user according to one embodiment of the invention.

### DETAILED DESCRIPTION

In the following detailed description of the present invention, references are made to the accompanying drawings that show, by way of illustration, specific embodiments in which the invention may be practiced. These embodiments are described in sufficient detail to enable those skilled in the art to practice the invention. It is to be understood that the various embodiments of the invention, although different from each other, are not necessarily mutually exclusive. For example, specific shapes, structures and characteristics described herein may be implemented as modified from one embodiment to another without departing from the spirit and scope of the invention. Furthermore, it shall be understood that the positions or arrangements of individual elements within each of the disclosed embodiments may also be modified without departing from the spirit and scope of the invention. Therefore, the following detailed description is not to be taken in a limiting sense, and the scope of the invention, if properly described, is limited only by the appended claims together with all equivalents thereof. In the drawings, like reference numerals refer to the same or similar functions throughout the several views.

Hereinafter, preferred embodiments of the present invention will be described in detail with reference to the accompanying drawings to enable those skilled in the art to easily implement the invention.

Configuration of an Entire System

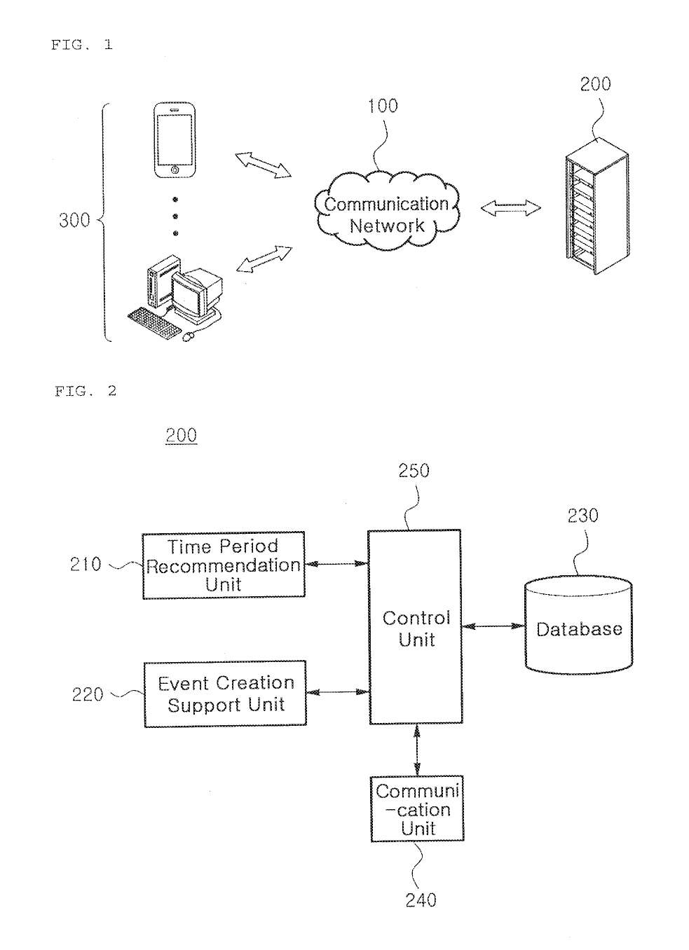

FIG. 1 schematically shows the configuration of an entire system for supporting schedule management according to one embodiment of the invention.

As shown in FIG. 1, the entire system according to one embodiment of the invention may comprise a communication network 100, a service provision system 200, and a user device 300.

First, the communication network 100 according to one embodiment of the invention may be implemented regardless of communication modality such as wired and wireless communications, and may be constructed from a variety of communication networks such as local area networks (LANs), metropolitan area networks (MANs), and wide area networks (WANs). Preferably, the communication network 100 described herein may be the Internet or the World Wide Web (WWW). However, the communication network 100 is not necessarily limited thereto, and may at least partially include known wired/wireless data communication networks, known telephone networks, or known wired/wireless television networks.

Next, the service provision system 200 according to one embodiment of the invention may function to simplify a process of determining a time period of an event that two or more users attend together, by determining, as candidate time periods, at least one time period judged to be suitable for event creation among time periods within a first user's schedule, with reference to context information of the first user; providing the first user with a first user interface for supporting the first user in inputting preference information for at least one of the determined candidate time periods; and determining, as preferred time periods, at least one candidate time period for which the first user has a preference of a predetermined level or higher among the candidate time periods, with reference to the preference information inputted through the first user interface.

The configuration and function of the service provision system 200 according to the invention will be discussed in detail in the following description.

Next, the user device 300 according to one embodiment of the invention is digital equipment capable of allowing a user to connect to and then communicate with the service provision system 200, and any type of digital equipment having a microprocessor and a memory means for computing capabilities, such as smart phones, tablets, desktop computers, notebook computers, workstations, personal digital assistants (PDAs), web pads, and mobile phones, may be adopted as the user device 300 according to rue invention,

Particularly, the user device 300 may include an application (not shown) to assist a user to receive services from the service provision system 200. The application may be downloaded from the service provision system 200 or a known web server (not shown) It is apparent that the application may be provided by implementing a calendar GUI of a conventional calendar program (e.g., a calendar GUI for schedule management in Microsoft Outlook), as necessary. At least a part of information for constructing the calendar GUI may be received from the service provision system 200.

Configuration of the Service Provision System

Hereinafter, the internal configuration of the service provision system 200 crucial for implementing the invention and the functions of the respective components thereof will be discussed.

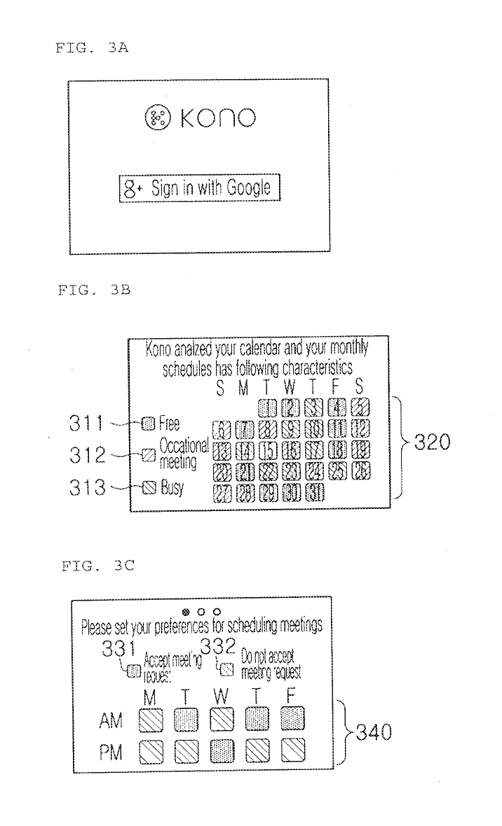

FIG. 2 illustratively shows the internal configuration of the service provision system according to one embodiment of the invention.

Referring to FIG. 2, the service provision system 200 according to one embodiment of the invention may comprise a time period recommendation unit 210, an event creation support unit 220, a database 230, a communication unit 240, and a control unit 250. According to one embodiment of the invention, at least some of the time period recommendation unit 210, the event creation support unit 220, the database 230, the communication unit 240, and the control unit 250 may be program modules to communicate with an external system (not shown). The program modules may be included in the service provision system 200 in the form of operating systems, application program modules, and other program modules, while they may be physically stored in a variety of commonly known storage devices. Further, the program modules may also be stored in a remote storage device that may communicate with the service provision system 200. Meanwhile, such program modules may include, but not limited to, routines, subroutines, programs, objects, components, data structures, and the like for performing specific tasks or executing specific abstract data types as will be described below in accordance with the invention.

First, according to one embodiment of the invention, the time period recommendation unit 210 may function to determine, as candidate time periods, at least one time period judged to be suitable for event creation among time periods within a first user's schedule, with reference to context information of the first user.

Here, according to one embodiment of the invention, the context information of the first user may include information on empty time periods within the first, user's schedule; information on a title, a time, a location, or other attending users of another event scheduled before or after an empty time period within the first user's schedule; demographic information of the first user; information on time periods preferred by the first user; information on locations preferred by the first user; information on the first user's activities on a social network service (SNS); information on chats that the first user has had with other users; information on the first user's to-do list; information on the first user's memos; information on a history of the first user's event implementation; and information on a time, a location, or attributes of an event that the first user desires to create. However, it is noted that the context information described herein not necessarily limited to the foregoing, and any other information may he used as the context information, as long as the objects of the invention may be achieved.

Specifically, according to one embodiment of the invention, a candidate time period extracted from the first user's schedule may be determined as a somewhat comprehensive time period encompassing all morning or afternoon time periods of a certain day. Further, according to one embodiment of the invention, a range or span of the candidate time period extracted from the first user's schedule may be arbitrarily determined as desired by the first user, through a first user interface to be described below.

For example, the time period recommendation unit 210 according to one embodiment of the invention may determine an empty time period corresponding to Monday when the first user frequently creates an event, among empty time periods within the first user's schedule, as a candidate time period suitable for event creation.

As another example, when the first user desires to create an in-house meeting, the time period recommendation unit 210 according to one embodiment of the invention may determine a time period in which another in-house meeting is scheduled as a candidate time period so that time efficiency of the first user may be increased, even if the time period is not an empty time period within the first user's schedule.

Meanwhile, according to one embodiment of the invention, the time period recommendation unit 210 may function to determine priorities of candidate time periods to be provided through the first user interface to be described below, with reference to the context information of the first user. According to one embodiment of the invention, a time period having a relatively high priority among several candidate time periods may be displayed preferentially (or with emphasis) compared to a time period having a relatively low priority, on the first user interface to be described below.

Next, according to one embodiment of the invention, the event creation support unit 220 may function to provide the first user with a first user interface for supporting the first user in inputting preference information for at least one of the determined candidate time periods.

Specifically, according to one embodiment of the invention, the first user interface provided to the first user may support the first user in making a selection (i.e., an alternate choice) of any one of preference and non-preference for the several determined candidate time periods, or making a selection (i.e., a threefold choice) of any one of preference, neutrality, and non-preference therefor. More specifically, according to one embodiment of the invention, the first user interface may include a GUI for supporting the first user in inputting a simple selection. operation such as a touch or click for each candidate time period to adjust his/her preference therefor. The GUI may allow a display state (e.g., color, shade, border, size, etc.) of each candidate time period to be changed according to the first user's preference state therefor.

Further, according to one embodiment of the invention, the first user interface provided to the first user may include schedule-related information for each candidate time period, which is provided in a form corresponding to the GUI for each candidate time period. Thus, the first user may easily and quickly recognize what the candidate time periods are, when inputting the preference information for the candidate time periods. For example, for a candidate time period corresponding to Friday morning, a square-shaped GUI for supporting the first user in adjusting his/her preference for the candidate time period may be provided, together with an alphabetical abbreviation for indicating the day of the week of the candidate time period, whether the candidate time period is in the morning or afternoon, and the like.

Furthermore, according to one embodiment of the invention, the first user interface provided to the first user may support the first user in further inputting preference information for a location of an event. For example, the first user interface may include a GUI for supporting the first user in personally specifying a preferred location on an electronic map.

Further, according to one embodiment of the invention, the event creation support unit 220 may function to determine, as preferred time periods of the first user, at least one candidate time period for which the first user has a preference of a predetermined level or higher among the candidate time periods, with reference to the preference information inputted through the first user interface.

For example, a candidate time period determined as a preferred time period by the first user among the candidate time periods provided through the first user interface may be included in the preferred time periods, and conversely, a candidate time period determined as a non-preferred time period by the first user among the candidate time periods provided through the first user interface may be excluded from the preferred time periods.

Further, according to one embodiment of the invention, the event creation support unit 220 may function to provide information on the first user's preferred time periods determined as above to a second user to attend an event together with the first user. According to one embodiment of the invention, upon a request from a second user who desires to create an event to attend together with the first user, the information on the preferred time periods of the first, user may be provided to the second user.

Specifically, according to one embodiment of the invention, the event creation support unit 220 may provide the second user with a second user interface for supporting the second user in inputting selection information for any one of the first user's preferred time periods provided as above, and may determine, as an event time period in which an event that the first and second users attend together is to be created, the preferred time period selected by the second user among the preferred time periods of the first user. More specifically, according to one embodiment of the invention, the event creation support unit 220 may function to determine priorities of the first user's preferred time periods to be provided through the second user interface, with reference to context information of the second user.

Meanwhile, according to one embodiment of the invention, a series of processes for determining the preferred time periods of the first user (i.e., determining the candidate time periods within the first user's schedule, providing the first user interface to the first user, and determining the preferred time periods of the first user) may be performed in response to the first or second user generating a request to create an event that the first and second users attend together.

In this case, according to one embodiment of the invention, the context information of the first user, on the basis of which the candidate time periods (consequently, the preferred time periods of the first user) are determined, may be updated in real time in response to the second user interface being provided the second user (i.e., in response to a state in which the second user may connect to the service provision system 200 according to the invention and input the selection information for the preferred time periods of the first user). Accordingly, the candidate time periods and the preferred time periods, which are determined on the basis of the context information of the first user, may also be updated in real time in response to the context information of the first user being updated.

That is, according to one embodiment of the invention, even if a first time point at which the preferred time periods of the first user is determined by the first user (i.e., a time point at which the context information of the first user is referred to) is different from a second time point at which the selection from the first user's preferred time periods is made by the second user (the time between the first and second time points may be negligibly short, but may be several hours to several days in some cases), the context information of the first user, the candidate time periods, and the preferred time periods may be updated in real time as above, so that the preferred time periods of the first user at the first time point may substantially coincide with those of the first user at the second time point.

Therefore, the present invention may minimize the inconsistency due to a situation change that may occur at a time between a first time point when the first user uses the service and a second time point when the second user uses the service (e.g., the inconvenience incurred when a time period, which was empty at the first time point and determined as a candidate time period and a preferred time period, is no longer empty as another event is created therein at the second time point), and may allow two or more temporally or spatially separated users to make an appointment to meet together such that the appointment may suit their schedules or situations without a significant handicap or sense of difference.

In this case, according to one embodiment of the invention, the time period recommendation unit 210 may determine, as candidate time periods, at least one time period judged to be suitable for creation of an event that the first and second users attend together, among time periods within the first user's schedule, with reference to the context information of the second user, as well as the context information of the first user.

However, in the present invention, a series of processes for determining the preferred time periods of the first user are not necessarily performed depending on (or temporally following) an event creation request being generated by the second user. According to one embodiment of the invention, a series of processes for determining the preferred time periods of the first user may be performed independently of an event creation request being generated by the second user.

In the above embodiments, a known artificial intelligence algorithm may be used in determining the candidate time periods with reference to the context information of the first or second user. It is noted that various artificial intelligence algorithms may be used without being limited to any specific artificial intelligence algorithm, as long as the objects of the invention may be achieved.

Meanwhile, the database 230 according to one embodiment of the invention may store context information of the first user, context information of the second information, and information on the first or second user's schedule. Although FIG. 2 shows that the database 230 is incorporated in the service provision system 200, the database 230 may be configured separately from the service provision system 200 as needed by those skilled in the art to implement the invention. Meanwhile, the database 230 according to the invention encompasses a computer-readable recording medium, and may refer not only to a database in a narrow sense but also to a database in a broad sense including file system-based data records and the like. The database 230 according to the invention may be even a collection of simple logs if one can search and retrieve data from the collection.

Next, the communication unit 240 according to one embodiment of the invention may function to enable the service provision system 200 to communicate with an external device such as the user device 300.

Lastly, the control unit 250 according to one embodiment of the invention may function to control data flow among the time period recommendation unit 210, event creation support unit 220, the database 230, and the communication unit 240. That is, the control unit 250 may control inbound data flow or data flow among the respective components of the service provision system 200, such that the time period recommendation unit 210, the event creation support unit 220, the database 230, and the communication unit 240 may carry out their particular functions, respectively.

### Embodiments

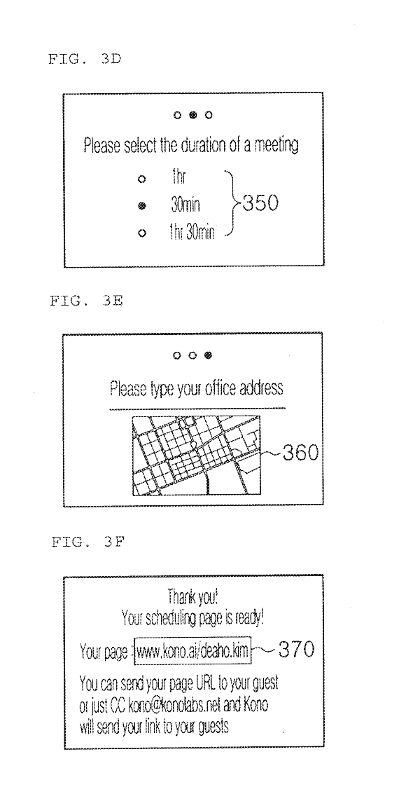

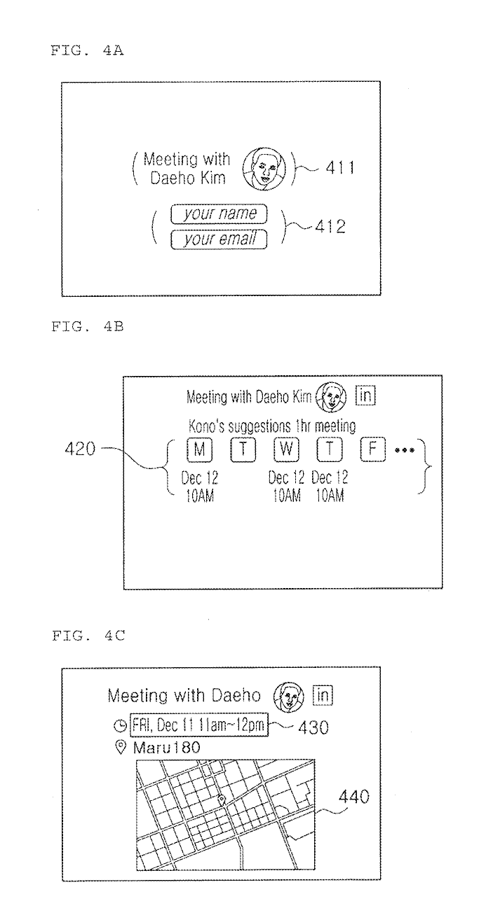

Hereinafter, embodiments for creating an event that a first user and a second user attends together according to the invention will be described in detail with reference to FIGS. 3A to 4C.

FIGS. 3A to 3F illustratively show service screens that may be provided to a first user according to one embodiment of the invention.

In the embodiment of FIGS. 3A to 3F, it may be assumed that a first user who is subscribed to the service according to the invention (i.e., a user named “Daeho Kim”) determines a time period that is suitable for event creation and preferred by the first user, with the help of the service provision system 200 according to the invention.

Referring to FIGS. 3A to 3C, as the first user logs in to the service according to the invention (see FIG. 3A), the first user may be visually provided with several candidate time periods 340 that are recommended as suitable for event creation, among the entire time periods 320 included in the first user's schedule managed by the service (see FIGS. 3B and 3C).

Here, according to one embodiment of the invention, each of the entire time periods 320 or the candidate time periods 340 may be distinctively displayed as an empty time period 311, a neutral time period 312, busy time period 313, or the like on the basis of, for example, whether another event is scheduled in the corresponding time period (see FIG. 3B), and each of the candidate time periods 340 may be distinctively displayed as a preferred time period 331, a non-preferred time period 332, or the like according to the preference information inputted from the first user (see FIG. 3C). Further, according to one embodiment of the invention, a square-shaped block indicating each candidate time period may be displayed in the service screens provided to the first user, together with an alphabetical abbreviation for schematically indicating schedule-related information for each candidate time period (e.g., M, T, W, T, of F indicating the day of the week, and AM or PM indicating the morning or afternoon).

Referring further to FIG. 3C, the first user may input an operation of simply touching or clicking on at least one of a plurality of graphical elements corresponding to a plurality of candidate time periods displayed on a display screen of the device 300, so that the candidate time period corresponding to the graphical element may be switched from a preference state to a non-preference state, or vice versa (see FIG. 3C).

Referring to FIGS. 3D and 3E, the first user may further input information on a preferred event duration 350 and a preferred event location 360 for a specific preferred time period (see FIGS. 3D and 3E).

Referring to FIG. 3F, the first user may be provided with information on a link for guiding other users to access information on the first user's preferred time periods determined as above (see FIG. 3F). According to one embodiment of the invention, the first user may transmit the link provided as above to other users through communication channel such as a text message or e-mail, thereby guiding them to access the information on the preferred time periods of the first user.

FIGS. 4A to 4C illustratively show service screens that may be provided to a second user according to one embodiment of the invention.

In the embodiment of FIGS. 4A to 4C, it may be assumed that a second user who is not subscribed to the service according to the invention suggests and creates an event that the first and second users attend together, with the help of the service provision system 200 according to the invention. According to one embodiment of the invention, the second user may connect to the service provision system 200 according to the invention via the link mentioned in FIG. 3F, so that the second user may receive the services shown in FIGS. 4A to 4C.

Referring to FIGS. 4A and 4B, a second user 412 may make a request to create an event to attend together with a first user 411 (see FIG. 4A), and as the request is generated, the second user may receive information on the preferred time periods of the first user from the service provision system 200 according to the invention (see FIG. 4B).

Referring to FIG. 4C, the second user may suggest creating an event by selecting a time period which the second user desires (or is available for) among the time periods preferred by the first user. Correspondingly, the service provision system 200 according to the invention may create an event that the first and second users attend together in a time period 430 selected by the second user among the preferred time periods of the first user, on condition that there is no change in the preferred time periods of the first user or no objection from the first user. Here, according to one embodiment of the invention, a location of the event may be determined as a location 440 predetermined by the first user (see FIG. 4C).

However, it is noted that the configurations of the service screens that may be provided to the first or second user according to the invention are not necessarily limited to those shown in FIGS. 3A to 4C, and may be changed without limitation as long as the objects of the invention may be achieved.

Although the embodiments for supporting the first and second users in creating a new event have been mainly described above, it is noted that the present invention is not necessarily limited to the above embodiments, and embodiments for supporting correction or deletion of an event existing in the first or second user's schedule may also be feasible without limitation.

Although the embodiments for supporting creation of an event that two users attend together have been mainly described above, it is noted that the present invention is not necessarily limited to the above embodiments, and embodiments for supporting creation of an event that three or more users attend together may also be feasible without limitation.

The embodiments according to the invention as described above may be implemented in the form of program instructions that can executed by various computer components, and may be stored on a non-transitory computer-readable recording medium. The non-transitory computer-readable recording medium may include program instructions, data files, data structures and the like, separately or in combination. The program instructions stored on the non-transitory computer-readable recording medium may be specially designed and configured for the present invention, or may also be known and available to those skilled in the computer software field. Examples of the non-transitory computer-readable recording medium include the following: magnetic media such as hard disks, floppy disks and magnetic tapes; optical media such as compact disk-read only memory (CD-ROM) and digital versatile disks (DVDs); magneto-optical media such as floptical disks; and hardware devices such as read-only memory (ROM), random access memory (PAN) and flash memory, which are specially configured to store and execute program instructions. Examples of the program instructions include not only machine language codes created by a compiler or the like, but also high-level language codes that can be executed by a computer using an interpreter or the like. The above hardware devices may be configured to operate as one or more software modules to perform the processes of the present invention, and vice versa.

Although the present invention has been described above in terms of specific items such as detailed elements as well as the limited embodiments and the drawings, they are only provided to help more general understanding of the invention, and the present invention is not limited to the above embodiments. It will be appreciated by those skilled in the art to which the present invention pertains that various modifications and changes may be made from the above description.

Therefore, the spirit of the present invention shall not be limited to the above-described embodiments, and the entire scope of the appended claims and their equivalents will fall within the scope and spirit of the invention.

What is claimed is:

1. A method implemented in a system for supporting schedule management, the system comprising a time period recommendation unit and an event creation support unit, and the method comprising the steps of:
the time period recommendation unit determining, as candidate time periods, at least one time period judged to be suitable for event creation among time periods within a first user's schedule, with reference to context information of the first user;
the event creation support unit providing the first user with a first user interface for supporting the first user in inputting preference information for at least one of the determined candidate time periods;
the event creation support unit determining, as preferred time periods, at least one candidate time period for which the first user has a preference of a predetermined level or higher among the candidate time periods, with reference to the preference information inputted through the first user interface;
the event creation support unit providing information on the determined preferred time periods to a second user to attend an event together with the first user;
the event creation support unit providing the second user with a second user interface for supporting the second user in inputting selection information for any one of the provided preferred time periods; and
the event creation support unit determining, as an event time period in which the event that the first and second users attend together is to be created, the preferred time period selected by the second user among the preferred time periods,
wherein in the step of determining the candidate time periods, at least one time period judged to be suitable for creation of the event that the first and second users attend together, among the time periods within the first user's schedule, is determined as the candidate time periods, with further reference to context information of the second user,
wherein the context information of the first, user is extracted from at least one of schedule information of the first user, biographical information of the first user, personalization information of the first user, online activity information of the first user, message information for the first user, and record information of the first user, and
wherein the context information of the second user is extracted from at least one of schedule information of the second user, biographical information of the second user, personalization information of the second user, online activity information of the second user, message information for the second user, and record information of the second user.

2. The method of claim 1, wherein the context information of the first user includes at least one of information on empty time periods within the first user's schedule; information on title, a time, a location, or other attending users of another event scheduled before or after an empty time period within the first user's schedule; demographic information of the first user; information on time periods preferred by the first user; information on locations preferred by the first user; information on the first user's activities on a social network service (SNS); information on chats that the first user has had with other users; information on the first user's to-do list; information on the first user's memos; information on a history of the first user's event implementation; and information on a time, a location, or attributes of an event that the first user desires to create.

3. The method of claim 1, wherein the preference information includes information on a selection of any one of preference and non-preference, or information on a selection of any one of preference, neutrality, and non-preference.

4. The method of claim 1, wherein the first user interface supports the first user in further inputting preference information for a location of the event.

5. The method of claim 1, wherein in the step of providing the first user interface, priorities of the candidate time periods to be provided through the first user interface are determined with reference to the context information of the first user.

6. The method of claim 1, wherein in the step of providing the second user interface, priorities of the preferred time periods to be provided through the second user interface are determined with reference to the context information of the second user.

7. The method of claim 1, wherein the context information of the first user is updated in real time in response to the second user interface being provided to the second user, and the candidate time periods and the preferred time periods are updated in real time on the basis of the context information of the first user being updated in real time.

8. A non-transitory computer-readable recording medium having stored thereon a computer program for executing the method of claim 1.

9. A system for supporting schedule management, comprising:
a time period recommendation unit configured to determine, as candidate time periods, at least one time period judged to be suitable for event creation among time periods within a first user's schedule, with reference to context information of the first user; and
an event creation support unit configured to provide the first user with a first user interface for supporting the first user in inputting preference information for at least one of the determined candidate time periods, and to determine, as preferred time periods, at least one candidate time period for which the first user has a preference of a predetermined level or higher among the candidate time periods, with reference to the preference information inputted through the first user interface,
wherein the event creation support unit provides information on the determined preferred time periods to a second user to attend an event together with the first user,
wherein the event creation support unit provides the second user with a second user interface for supporting the second user in inputting selection information for any one of the provided preferred time periods, and determines, as an event time period in which the event that the first and second users attend together to be created, the preferred time period selected by the second user among the preferred time periods,
wherein the time period recommendation unit determines, as the candidate time periods, at least one time period judged to be suitable for creation of the event that the first and second users attend together, among the time periods within the first user's schedule, with further reference to context information of the second user,
wherein the context information of the first user is extracted from at least one of schedule information of the first user, biographical information of the first user, personalization information of the first user, online activity information of the first user, message information for the first user, and record information of the first user, and
wherein the context information of the second user is extracted from at least one of schedule information of the second user, biographical information of the second user, personalization information of the second user, online activity information of the second user, message information for the second user, and record information of the second user.

10. The system of claim 9, wherein the context information of the first user includes at least one of information on empty time periods within the first user's schedule; information on a title, a time, a location, or other attending users of another event scheduled before or after an empty time period within the first use schedule; demographic information of the first user; information on time periods preferred by the first user; information on locations preferred by the first user; information on the first user's activities on a social network service (SNS); information on chats that the first user has had with other users; information on the first user's to-do list; information on the first user's memos; information on a history of the first user's event implementation; and information on a time, a location, or attributes of an event that the first user desires to create.

11. The system of claim 9, wherein the preference information includes information on a selection of any one of preference and non-preference, or information on selection of any one of preference, neutrality, and non-preference.

12. The system of claim 9, wherein the first user interface supports the first user in further inputting preference information for a location of the event.

13. The system of claim 9, wherein the time period recommendation with determines priorities of the candidate time periods to be provided through the first user interface, with reference to the context information of the first user.

14. The system of claim 9, wherein the event creation support unit determines priorities of the preferred time periods to be provided through the second user interface, with reference to the context information of the second user.

15. The system of claim 9, wherein the context information of the first user is updated in real time in response to the second user interface being provided to the second user, and the candidate time periods and the preferred time periods are updated in real time on the basis of the context information of the first user being updated in real time.
